(19) United States
(12) Patent Application Publication
(10) Pub. No.: US 2026/0048613 A1
(43) Pub. Date: Feb. 19, 2026

(54) VERSATILE WHEEL FOR MULTIDIRECTIONAL MOVEMENT

(71) Applicant: ROBOTZONE LLC, Winfield, KS (US)

(72) Inventors: Brian T. PETTEY, Winfield, KS (US); Joshua D. ORR, Winfield, KS (US); Ethan DOAK, Wichita, KS (US)

(21) Appl. No.: 19/286,357

(22) Filed: Jul. 31, 2025

Related U.S. Application Data
(60) Provisional application No. 63/682,420, filed on Aug. 13, 2024.

(51) Int. Cl. B60B 19/00; B60B 19/12

(52) U.S. Cl. CPC B60B 19/003; B60B 19/125

(57) ABSTRACT

A multidirectional wheel assembly includes a set of rollers for multidirectional movement. The multidirectional wheel includes multiple rollers mounted around the wheel's circumference, with each roller rotating around an axis that is not parallel to the main rotation axis of the wheel. Each roller rotates independently around a separate axis. Each roller includes a series of traction inducing elements. These traction inducing elements provide increased traction when traversing in the forward, backward, and lateral direction on various surfaces.

### CROSS-REFERENCE TO RELATED APPLICATION

The present application is based on and claims the benefit of U.S. provisional patent application Ser. No. 63/682,420, filed Aug. 13, 2024, the content of which is hereby incorporated by reference in its entirety.

### FIELD OF THE DESCRIPTION

The present description relates to wheel assemblies capable of multidirectional movement. More specifically, the present description relates to wheel assemblies which provide machines with the ability to move forward, backward, directly lateral, and turn about its own central axis.

### BACKGROUND

Wheel assemblies are fundamental components used in a variety of machines to facilitate movement across surfaces. Traditional wheel assemblies provide motion in the forward and backward direction, and rely on steering mechanisms (i.e. steering wheels) to change direction. Multidirectional wheel assemblies have been introduced to allow machines to move laterally or turn about the machine's central axis by rotating the wheels in opposite directions at the same time. For example, omni-directional wheels (omni-wheels) include a central hub and rollers mounted around the central hub's circumference. These rollers are mounted around the circumference of the central axis such that each roller rotates around an axis perpendicular to the omni-wheel's axis of rotation, allowing multidirectional movement. A similar style wheel, referred to as a mecanum wheel, has a comparable assembly providing similar multidirectional movement. A mecanum wheel includes a central hub with rollers mounted around the circumference of the central hub at approximately a 45-degree angle relative to the wheel's axis of rotation, providing a roller axis at roughly 45 degrees to the wheel's axis. Traditionally, each wheel style includes a plurality of smooth, substantially non-deformable rollers for use on hard floor surfaces, such as concrete.

Similar to skid steer and tracked vehicles, omni-wheels and mecanum wheels are often used in holonomic drive systems on these smooth, hard surfaces. More specifically, these multidirectional wheels are commonly used in mobile platforms such as mobile machines, robotics, material handling equipment, and other systems where multidirectional movement is desired on smooth, hard surfaces.

The discussion above is merely provided for general background information and is not intended to be used as an aid in determining the scope of the claimed subject matter.

### SUMMARY

A multidirectional wheel assembly includes a central hub, a frame, and a plurality of brackets connected to the outer periphery. The assembly also includes a plurality of rollers connected to the plurality of brackets. The central hub rotates around a first axis, and each roller in the plurality of rollers rotates independently around a second axis. Each roller in the plurality of rollers has a surface including a series of raised traction inducing elements. In one example, the plurality of rollers can be an integrated part of the multidirectional wheel assembly. A plurality of rollers integrated into a multidirectional wheel such that each roller in the plurality includes a repeated series of raised traction inducing elements is also provided.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1A is a perspective view of an omni-wheel according to the prior art.

FIG. 1B is a perspective view of a mecanum wheel according to the prior art.

FIG. 2A is a face elevation view of a mecanum wheel according to one example.

FIG. 2B is a face elevation view of a mecanum wheel according to one example.

FIG. 3 is a perspective view of a mecanum wheel according to one example.

FIG. 4 is a front elevation view of a mecanum wheel according to one example.

FIG. 5A is a perspective view of a roller for a multidirectional wheel according to one example.

FIG. 5B is a front elevation view of a roller for a multidirectional wheel according to one example.

FIG. 5C is a side elevation view of a roller for a multidirectional wheel according to one example.

FIG. 6 is a perspective view of a plurality of rollers having traction inducing elements according to one example.

FIG. 7 is a perspective view of an omni-wheel according to one example.

FIG. 8 is a schematic top plan view of a machine having a multidirectional wheel system according to one example.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of principles of the present disclosure are fully contemplated as would normally occur to one skilled in the art to which the disclosure relates. In particular, it is fully contemplated that the features, components, and/or steps described with respect to one example can be combined with the features, components, and/or steps described with respect to other examples of the present disclosure.

As discussed above, multidirectional wheels provide mobile machines with multidirectional movement not available with traditional style wheels. For instance, multidirectional movement allows a machine to rotate in place about the machine's central axis and/or move in a lateral direction. A traditional wheel assembly includes a set of rear wheels fixed in orientation while a set of front wheels can be swiveled with a steering mechanism, such as a steering wheel. The steering mechanism can adjust the orientation of the set of front wheels to change the heading of the vehicle and change direction. On the other hand, multidirectional wheels include all wheels being fixed in orientation and angled rollers that rotate independently from the wheel's axis of rotation. Multidirectional wheels provide the ability to move in additional directions by rotating the wheels in opposite directions. For example, the front and rear wheels can be rotated in opposite directions to provide lateral movement or rotation around a central axis. Omni-wheels include rollers mounted along the wheel's circumference, such that the rollers are oriented perpendicular to the wheel's axis of rotation. This allows the wheel to move laterally, in addition to the traditional forward and backward direction of a conventional wheel. Mecanum wheels are a similar type of wheel, featuring rollers arranged at a 45-degree angle relative to the wheel's axis of rotation. When used in a four-wheel configuration, these specialized wheels allow a vehicle or machine to move in any direction across a surface by independently controlling each wheel's rotation speed and rotation direction.

These multidirectional wheels, such as omni-wheels and mecanum wheels, have traditionally been used in environments having a hard floor surface such as concrete, wood, and/or polished stone surfaces. For example, a forklift operating in a warehouse with a concrete floor can be equipped with a set of omni-wheels for multidirectional movement. A warehouse forklift typically experiences limited workspace between obstacles, such as shelving units, making it difficult to turn and navigate the obstacles with a traditional wheel assembly and steering system. A forklift equipped with four omni-wheels, one at each corner, can rotate in place or move laterally without having to travel forward or backward (relative to a front end and back end of the forklift). To achieve a turn-in-place rotation around the forklift's central axis, the four wheels are driven in opposing directions; the front-left and back-right wheels rotate forward, while the front-right and back-left wheels rotate backward. The rollers of each omni-wheel allow each wheel to travel around the forklift's central axis at the same time.

Multidirectional wheels, such as omni-wheels, have traditionally incorporated rollers made from smooth, non-deformable materials to minimize friction against the ground surface. In this instance, non-deformable material can include metal, polycarbonate, resin, or other materials that resist substantial deformation under a given machine's weight or added load. This smooth, non-deformable roller design allows a machine to maneuver on hard, smooth surfaces with reduced resistance, especially during lateral or rotational movement. Movements such as in-place rotation or lateral strafing require the wheels to undergo more rotation than the rotation needed for simple forward or backward motion. Using the forklift example, the forklift operating on a hard concrete warehouse floor often uses omni-wheels with smooth rollers to reduce friction during multidirectional maneuvers. Each wheel is rotated in a specific direction around the wheel's axis of rotation, which causes each roller to rotate around a roller axis, independent of the wheel's axis of rotation, and ultimately causes the machine to maneuver in a specific way (e.g., sideways movement). However, for these maneuvers to be effective, the rollers of the omni-wheels must remain in contact with the floor surface. The wheels typically carry a substantial load, for example from the machine itself or an added load on the machine, which applies a downward force that promotes contact between the rollers and the floor. This downward force and roller contact allows the machine to move smoothly without relying on added wheel traction, similar to how slick tires in drag racing operate by maximizing surface contact rather than grip.

As discussed, traditional multidirectional wheels include smooth, non-deformable rollers for effective use on hard, smooth surfaces. Minimal resistance between the smooth rollers and the hard floor surface allow the machine to move laterally or rotate in place smoothly. As a result, machines using multidirectional wheels are generally limited to hard, smooth floor surfaces such as concrete. For example, if a machine having multidirectional wheels were placed on a softer floor surface, such as foam or rubber, the softer floor surface would conform to the smooth rollers and cause operational disadvantages. The conformity would cause slippage between the wheels and soft floor surface resulting in reduced control. The soft floor surface would further require the machine to have exact weight distribution between each wheels. For example, if the machine had more weight at the rear than at the front, the uneven weight distribution would cause the soft surface to conform to the smooth rollers of the rear wheels, more than the front wheels. Then, if the machine attempted a directly lateral strafe maneuver, an uneven force would be generated between the wheels rotating in opposing directions causing the machine to travel in an undesired direction. In other words, the rear wheels holding more weight, sinking into the softer surface, would generate less force than the front wheels, causing the machine to move diagonally backward instead of directly lateral.

To reduce the slippage and conformity by the soft floor surface, traction components could be incorporated onto the rollers of the multidirectional wheels. However, traction on multidirectional wheels has traditionally been avoided. Additional wheel traction would result in increased resistance as the wheels propel the machine and would thus require more power from a machine's power source (e.g., motor, battery, etc.) during multidirectional maneuvers. Therefore, traction on multidirectional wheel assemblies has been avoided as traction would require more power output (i.e. less efficient). Additionally, wheel traction would put excess stress on the wheel assembly, such as wheel bearings, machine chassis, axle rods, fasteners, and/or other components. For example, wheel traction grips against a hard surface, the wheel traction would generate excess vibration as the wheels rotate to perform multidirectional maneuvers. Therefore, traction on multidirectional wheel assemblies has been avoided, and multidirectional wheels are currently limited to hard, smooth floor surface environments.

However, many machines operating in softer floor surface environments can benefit from an applicable multidirectional wheel assembly. For example, in the increasingly growing field of competitive robotics, many competition floor surfaces are constructed using foam, rubber, or other materials. In some examples, the floor surface can even include a loose material such as sand or dirt. In another example, medical imaging robots operate in certain facilities (e.g., physical therapy centers) which commonly use foam mat flooring. These are just examples, and it is understood that multidirectional wheels could also be applied in other machines operating on soft floor surfaces. As traditional multidirectional wheels are designed for and are currently limited to hard surfaces, the competitive robots and machines are currently limited to either using traditional wheel assemblies with traction or multidirectional wheel assemblies with hard, smooth rollers. With traditional wheel assemblies having traction, the machine loses the ability to perform multidirectional maneuvers. With multidirectional wheel assemblies having hard rollers, the machine experiences slippage and reduced control. Conventional multidirectional wheel assemblies on soft floor surfaces restrict optimal performance as the conventional hard rollers lack sufficient traction on the softer floor surfaces. However, as discussed above, adding traction to the rollers has traditionally been avoided due to, for example, the traction generating excess stress on the machine and/or requiring more power output to perform maneuvers.

In many cases involving competitive robotics and/or other machines operating on soft floor surfaces, the additional friction/drag from added traction elements would be accepted due to the trade-off for improved acceleration and control. For example, in competitive robotics, traction elements disposed on each roller could improve the robot's ability to perform rapid starts and stops, which is crucial for maneuvering through complex courses and completing tasks quickly. Additionally, increased acceleration and precise traction control are desired in many competitive robotic environments. In another example, in situations where the robot's initial movement path is pre-programmed, or the robot is tracked via its odometry measurements, increased traction can provide more precise odometry measurements, as the revolutions per minute (RPM) of the wheels are more consistently trackable. This increased precision is important for maintaining accurate navigation and positioning during these robotic competitions, and, in one example, outweighs the limitations caused by the additional friction/resistance caused by the traction components.

Therefore, the present description provides a multidirectional wheel assembly with a plurality of rollers having traction elements. In one example, each roller on the multidirectional wheel assembly can include a set of traction elements to increase grip on softer floor surfaces such as foam, rubber, or other surface materials.

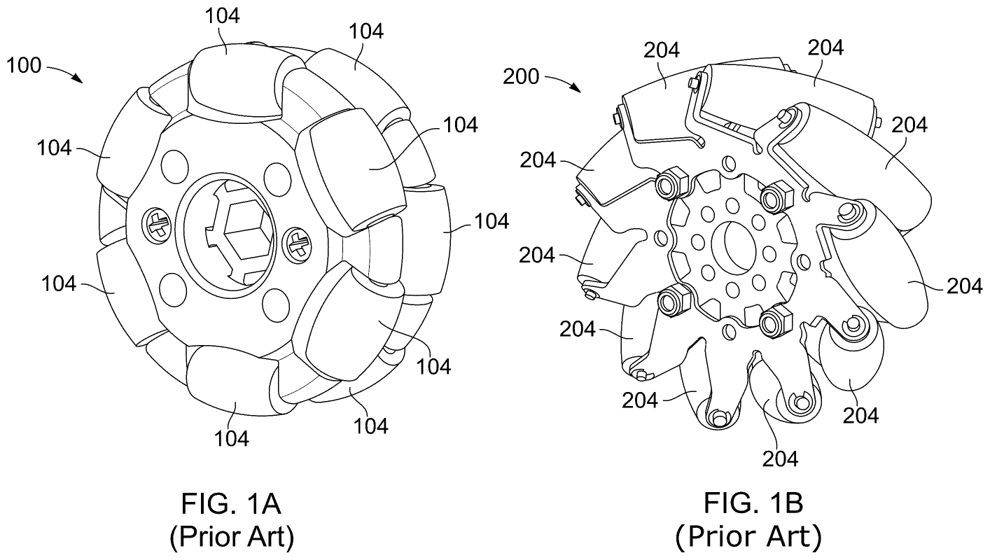

FIG. 1A is a perspective view of an omni-wheel according to the prior art. Omni-wheel 100 includes body 102 and rollers 104. Rollers 104 are mounted on body 102 such that the axis of rotation of each roller is perpendicular to the axis of rotation of body 102. The axis of rotation in this example, is an axis through the central hub for which the wheel rotates around to propel a machine in a forward or backward direction. Rollers 104 are generally designed to include a surface having a smooth material for minimal drag and resistance when performing lateral maneuvers on hard floor surfaces, as discussed above. Rollers 104 are traditionally made of a rigid plastic or another material that does not significantly flex or deform during operation. Therefore, omni-wheel 100 having rollers 104 is limited to hard floor environments such as concrete surfaces.

FIG. 1B is a perspective view of a mecanum wheel in accordance with the prior art. Mecanum wheel 200 includes body 202 and rollers 204. Rollers 204 are mounted to body 202 such that the axis of rotation of each roller is substantially at a 45-degree angle relative to the axis of rotation of the body portion. The axis of rotation in this example, is an axis through the central hub for which the wheel rotates around to propel a machine in a forward or backward direction. Rollers 204 are spaced apart such that each roller rotates independently. Traditionally, rollers 204 are designed to include a material having a smooth surface for minimal drag and resistance when performing lateral maneuvers, as discussed above. Rollers 204 are traditionally made of a rigid plastic or another material that does not significantly flex or deform during operation. Therefore, mecanum wheel 200 having rollers 204 is limited to hard floor environments such as concrete surfaces.

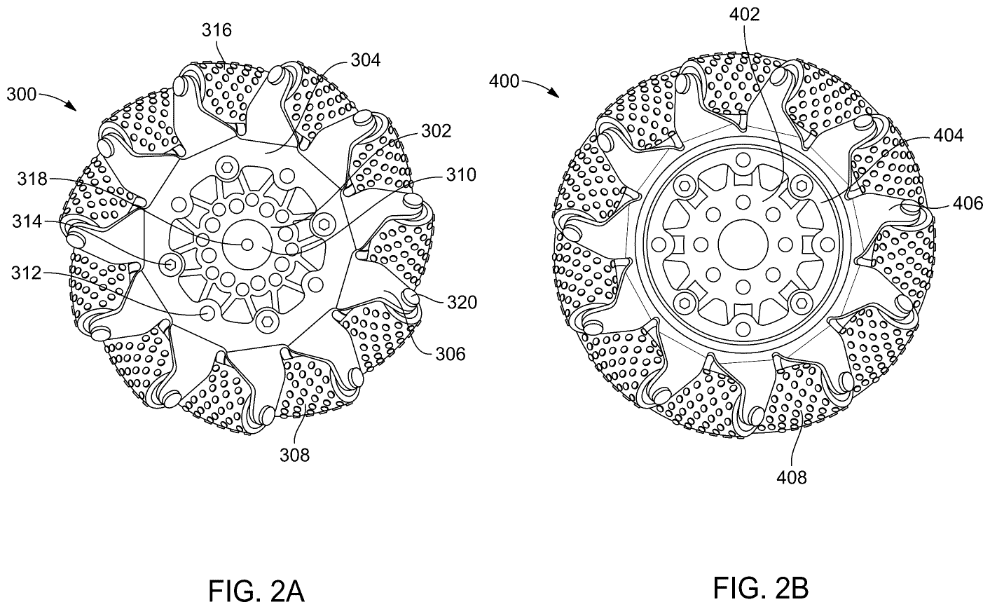

FIG. 2A is a face elevation view of a mecanum wheel according to one example. Mecanum wheel 300 includes central hub 302, frame 304, brackets 306, and rollers 308. In one example, one or more of mecanum wheel 300 are deployed on a forklift. In another example, one or more of mecanum wheel 300 are deployed on a robot machine. In one example, the robot machine is an imaging robot or competitive robot operating on a soft floor surface such as foam or rubber. In another example, the robot machine is the forklift, and the forklift is operating on a soft floor surface. It is understood that one or more of mecanum wheel 300 can be installed onto other machines and vehicles as well. In one example, central hub 302 has aperture 310. Aperture 310 can receive an axle rod, connecting shaft, or other connecting component to attach mecanum wheel 300 to a mobile robot or vehicle. Aperture 310 can also define an axis of rotation of wheel 300. In one example, axis 318 extends through aperture 310, perpendicular, or substantially perpendicular, to a plane of aperture 310. In another example, axis 318 extends through aperture 310 not parallel to a plane of aperture 310. In one example, aperture 310 receives and is connected to an axle of a frame (i.e. chassis) of a mobile machine assembly, and axis 318 is substantially parallel to the axle.

Central hub 302 also includes fastening holes 312. Fastening holes 312 can receive a respective screw or other fastening component to couple central hub 302 to frame 304. Frame 304 is coupled to central hub 302 through fasteners 314. Fasteners 314 can be bolts, screws or other fastening components suitable for coupling frame 304 to central hub 302. It is understood that the opposite side of mecanum wheel 300 (i.e. the opposite side not shown in FIG. 2A) can include an additional frame component, independent from frame 304. In one example, the additional frame component can be similar to or the same as frame 304. In one example, fasteners 314 extends through frame 304, central hub 302, and the additional frame component on the opposite side of mecanum wheel 300. As shown, mecanum wheel 300 includes several components assembled together. However, in another example, mecanum wheel 300 can be made from a single piece (e.g., molded piece). For instance, mecanum wheel 300 can be made with a process such as injection molding or three-dimensional (3D) printing to achieve a wheel having a single piece. Therefore, in one example, fasteners 314 can be optional.

In one example, frame 304 includes a series of brackets. Frame 304 includes brackets 306 mounted around the circumference of frame 304. Of course, the additional frame component disposed on the opposite side of wheel 300 can include a respective series of brackets corresponding to the brackets shown in FIG. 2A. Brackets 306 are positioned at an angle, relative to the central axis of rotation of wheel 300 (i.e. axis 318). As shown for wheel 300, brackets 306 can be positioned at an angle between about 30-50 degrees, relative to axis 318. In some examples, brackets 306 can be perpendicular to axis 318. Of course, other bracket angles are contemplated.

Each bracket 306 can receive a roller 308. In one example, rollers 308 are mounted to brackets 306 via connector 320. Each roller 308 can be positioned between bracket 306 and the respective bracket of the additional frame component on the opposite side of wheel 300. Each connector 320 can extend through bracket 306, roller 308, and the respective bracket on the opposite side not illustratively shown in FIG. 2A. In one example, connector 320 is a rod and roller bearing. It is understood that more or fewer of brackets 306, rollers 308, and connectors 320 can be included than what is illustratively shown in FIG. 2A. Rollers 308 provide mecanum wheel 300 with continuous contact with a floor surface as mecanum wheel 300 traverses in the forward, backward, or lateral direction. Rollers 308 can also allow a mobile machine to perform a turn-in-place rotation. For example, when wheel 300 is used in a four-wheel configuration on a mobile machine, wheels 300 allow the mobile machine to move in any direction across a surface by independently controlling each wheel's rotation speed and rotation direction. For example, an operator can drive each wheel 300 on the machine in opposing directions. To achieve a turn-in-place movement, in the four-wheel configuration, the operator can control the front-left and back-right wheels to rotate forward and control the front-right and back-left wheels to rotate backward. Additionally, the operator can control the mobile machine to move laterally to the left or laterally to the right, without moving in the forward or backward direction. To move the mobile machine directly to the left, the front-left and back-left wheels rotate backward, while the front-right and back-right wheels rotate forward. As the wheels turn, the rollers redirect the force sideways, causing the mobile robot to move left without rotating or moving forward. To move directly to the right, the wheel directions are reversed: the left-side wheels rotate forward, and the right-side wheels rotate backward. Further, diagonal movement can be achieved using a combination of these processes.

Each roller 308 also includes a series of raised traction inducing elements 316 which surround the surface area of each roller 308. As shown, raised traction inducing elements 316 can be positioned in a predefined traction pattern. It is understood that the number of traction elements 316 and the traction pattern can vary from what is illustratively shown in FIG. 2B. In one example, each roller 308 can include the same pattern of traction inducing element 316 to provide a uniform set of rollers 308. In another example, each roller 308 can include a different traction pattern of element 316. Traction inducing elements 316 can be arranged in a repeated series or predetermined pattern. In one example, the traction pattern and appearance of elements 316 depends on the floor surface condition. For instance, a soft floor may require more aggressive, defined traction elements while a harder floor may require less distinct traction elements. In another example, it can be efficient to alternate each roller with traction elements (i.e. every other roller includes traction elements).

FIG. 2B is a face elevation view of a mecanum wheel according to one example. Mecanum wheel 400 includes central hub 402, frame 404, brackets 406, and rollers 408. Mecanum wheel 400 can be similar to or the same as mecanum wheel 300. In one example, mecanum wheel 400, as shown in FIG. 2B, has a similar construction to mecanum wheel 300 in FIG. 2A. Mecanum wheel 400 illustrates how rollers 408 can be arranged (i.e. angled) to form a uniform perimeter such that wheel 400 maintains sufficient contact with the floor surface during operation. For example, rollers 408 maintain continuous contact with a floor surface to provide minimal vibration during rotation of mecanum wheel 400 and movement of an associated mobile machine. Additionally, rollers 408 are spaced apart to allow each roller to rotate independently of an adjacent roller.

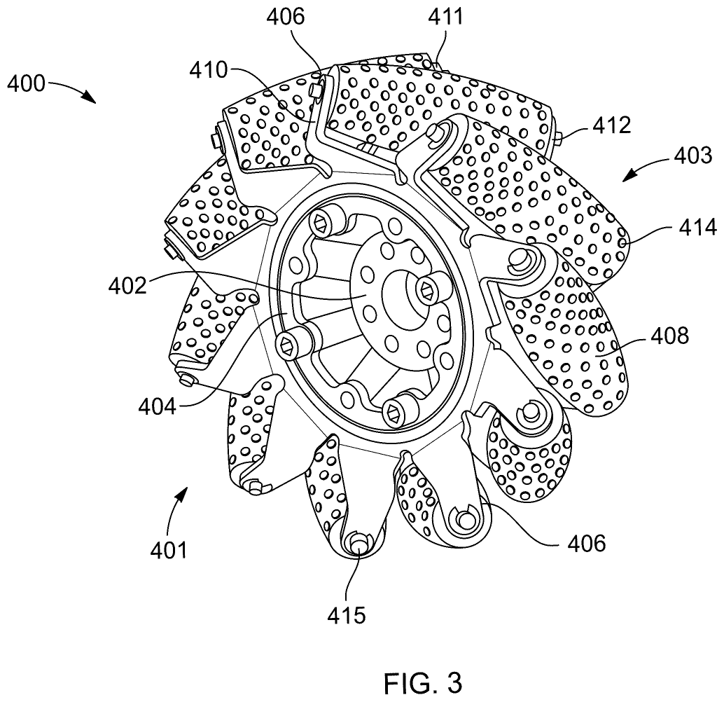

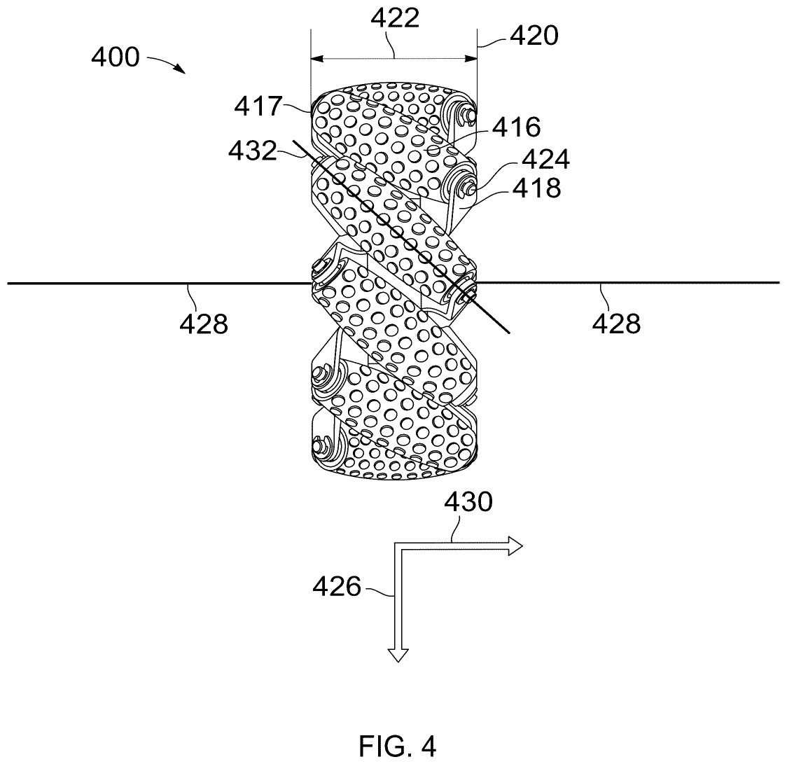

FIG. 3 is a perspective view of the mecanum wheel as shown in FIG. 2B. As discussed, mecanum wheel 400 includes central hub 402, frame 404, brackets 406, and rollers 408. Mecanum wheel has first side 401 and second side 403. In one example, first side 401 is opposite to second side 403. First side 401 includes brackets 406. Additionally, second side 403 includes brackets 411. Brackets 406, of first side 401, include first side panel 410, while brackets 411, on second side 403, include second side panel 412. A distance separates the first and second side panels of the respective brackets. In one example, wheel 400 is made of a single piece, and includes a single bracket assembly. As shown on first side 401, each bracket 406 extends outward from frame 404 and is mounted at an angle of approximately 30-50 degrees relative to a central axis of rotation of mecanum wheel 400, as is discussed in more detail below with regard to FIG. 4. In one example, brackets 406 are mounted at a 45-degree angle relative to the central axis of rotation. In another example, brackets 406 can be mounted perpendicular to a central axis of rotation. Rollers 408 are mounted in a uniform configuration around the perimeter of mecanum wheel 400 corresponding to each bracket and include traction inducing elements 414. The uniform configuration of mounted rollers 408 means that mecanum wheel 400 will maintain continuous contact with the floor with minimal vibration as the wheel rotates in any direction. Additionally, each roller 408 can rotate independently from each adjacent roller and mecanum wheel 400 about an independent roller axis. This independent roller axis is provided by a roller axle which is at, in one example, approximately a 45-degree angle relative to the axis of rotation of the central hub in a forward or backward direction. Each roller 408 is mounted between fist side panel 410 and second side panel 412 of each bracket by connector 415. Connector 415 can be a roller axle, a roller bearing, a combination of both, or another connecting mechanism. In one example, each roller 408 includes a central bore than receives connector 415.

FIG. 4 is a front view of mecanum wheel 400 as shown in FIG. 3. Mecanum wheel 400 includes roller 416, bracket 418, and roller axle 424. In one example, roller 416 can be one of rollers 408, bracket 418 can be one of bracket 406, and roller axle 424 can be one of connector 415 discussed above. For simplicity, roller 416, bracket 418, and roller axle 424 are used to describe the set of rollers 408, brackets 406, and connector 415 as shown in FIG. 3. Roller 416 is mounted to bracket 418 through the use of a wheel bearing and/or roller axle 424. It is understood that a respective bracket is disposed on the other side of roller 416 and corresponds to bracket 418. Roller 416 is mounted between distance 420 of bracket 418 and respective bracket 417. In one example, distance 420 has a length 422 that is relative to a width of a wheel assembly. By having roller axle 424, each roller (each of rollers 408 and/or roller 416) is able to rotate independently about an axis that is different than the axis of rotation of mecanum wheel 400. For example, as mecanum wheel 400 traverses in a forward direction along vector 426, rollers 408 rotate with mecanum wheel 400 about wheel axis 428. However, as mecanum wheel 400 traverses in a lateral direction along vector 430, rollers 408 rotate independently about roller axis 432 which produces a net driving force in the direction of vector 430. Roller axle 424 integrated within roller 416 allows roller 416 to rotate about roller axis 432 and propel mecanum wheel 400 across a given floor surface.

In one example, a mobile robot can be equipped with four of mecanum wheel 400 shown in FIG. 4. The robot equipped with four mecanum wheels, one at each corner, can achieve multidirectional movement across a surface plane. When the wheels rotate forward or backward, the rollers rotate with the wheel about the axis of rotation (i.e. axis 428), allowing traditional wheel movement (i.e. forward and backward). To move laterally, pairs of wheels on opposite corners rotate in opposite directions. For example, in a four-wheel configuration, the front left and rear right wheels might rotate clockwise while the front right and rear left wheels rotate counterclockwise. This opposing rotation generates a force that combines to produce a net lateral force, moving the vehicle sideways. By controlling the speed and direction of each wheel's rotation, the robot can achieve precise lateral movement and turn in place maneuvers efficiently.

Roller 416 includes traction inducing elements 414 which, in one example, surround the surface area of roller 416. In one example, as traction inducing elements 414 contact a soft floor surface in a lateral traverse, traction inducing elements 414 increase acceleration in the lateral direction. Similarly, traction inducing elements 414 also increase acceleration in the forward and backward directions. Traction inducing elements 414 increase resistance between the wheel and a floor surface, however, as discussed above, this increased resistance is accepted in many cases. Traction inducing elements 414 can also provide a more precise odometry measurement as the mobile robot maneuvers in the forward, backward, or lateral direction. A precise odometry measurement is a result from the mecanum wheel 400 having more grip on the floor surface such that the rotation of mecanum wheel 400 is more consistently trackable through any suitable measurement system, such as an inertial based odometer, a hybrid visual-inertial odometry (VIO) system, or other measurement system.

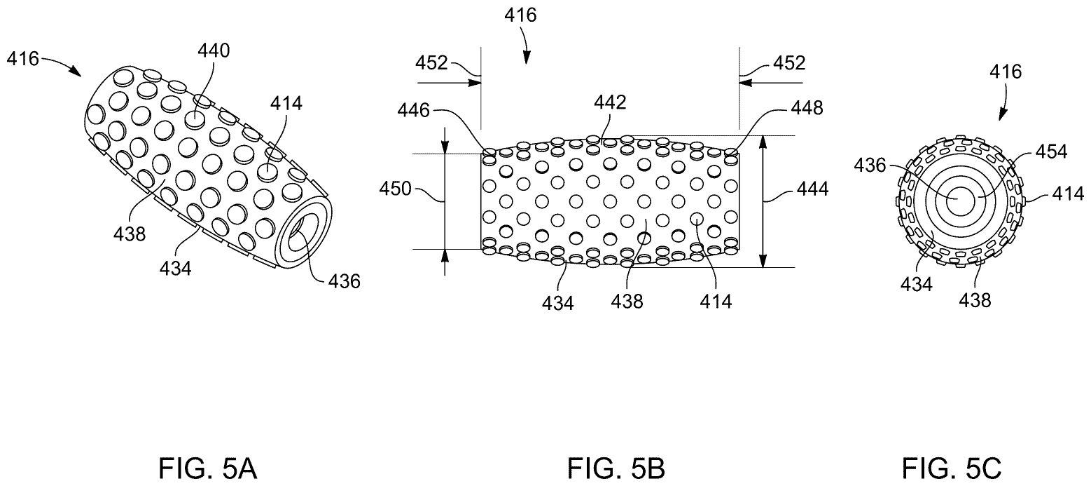

FIG. 5A is a perspective view of roller 416 of mecanum wheel 400 as shown in FIG. 4. Roller 416 includes body 434, internal bore 436, surface 438, and traction inducing elements 414. Roller 416 can be installed onto a multidirectional wheel to increase traction, such as on foam or rubber surfaces. Internal bore 436 extends lengthwise through roller 416 and is configured to receive an axle or shaft to allow roller 416 to have independent rotation relative to the structure of a multidirectional wheel in which roller 416 is integrated into. Surface 438 surrounds body 434 and can be made from plastic, polyurethane, rubber, or other materials. In one example, roller 416 can be made from a single material. In another example, roller 416 can be made from a combination of materials.

As shown, traction inducing elements 414 are raised projections, projecting from surface 438 in a predefined pattern, such that traction inducing elements 414 are distanced from one another. In one example, traction inducing elements 414 are a series of raised dotted projections 440 arranged in a helical pattern around roller 416, relative to a place of the surface of roller 416, as shown in FIG. 5A-5B. In another example, traction inducing elements 414 can be arranged as a set of ridges or linear bands extending around roller 416. With a set of multiple ridge elements, each ridge can project from the surface material at a predetermined height and is arranged in a selected pattern, such as a cross hatched pattern. With linear bands, the bands can be raised and follow a pattern path around a roller such as a wavy path, cross hatched path, or zig-zag path. Alternatively, traction inducing elements 414 can include recessed portions relative to the plane of the surface of roller 416. It is understood that any variation of traction inducing element or traction element pattern is contemplated.

FIG. 5B is a front view of roller 416 of mecanum wheel 400 according to one example. Roller 416 includes body 434, surface 438 and traction inducing elements 414. As shown, body 434 can include a length 452. In one example, body 434 has a cylindrical shape. In one example, the roller axis is substantially parallel to length 452 of roller 416. In one example, roller 416 includes a tapered shape. This tapered profile begins at center point 442 having first height 444 and tapering down to end points 446, 448 having second height 450. Roller 416 is constructed with this tapered shape to allow wheel 400 to smoothly contact the ground throughout every rotation of each roller. A tapered shape of roller 416 prevents interference of the end points 446, 448 as each roller contacts a floor surface, reducing vibration. With a tapered shape, roller 416 maintains continuous engagement of traction inducing elements 414 to a floor surface as a mecanum wheel rotates in a forward direction. As the mecanum wheel traverses in a lateral direction, the tapered design allows each roller to maintain consistent pressure and grip to result in smoother transitions and minimize vibration.

FIG. 5C is a side view of roller 416 of mecanum wheel 400 according to one example. Roller 416 includes body 434, surface 438, and traction inducing elements 414. As discussed above, body 434 includes internal bore 436. Bore 436 can accommodate an axle shaft. Body 434 can also receive bearing 454. Bore 436 can extend through bearing 454. Bearing 454 can facilitate rotation about a roller axis. As shown, surface 438 includes traction inducing elements 414. As shown, traction inducing elements 414 include a low-profile traction pattern. For example, traction inducing elements 414 are less defined for a given floor surface. However, it is understood that the traction pattern and definition of elements 414 can vary from what is shown in FIG. 5A-5C.

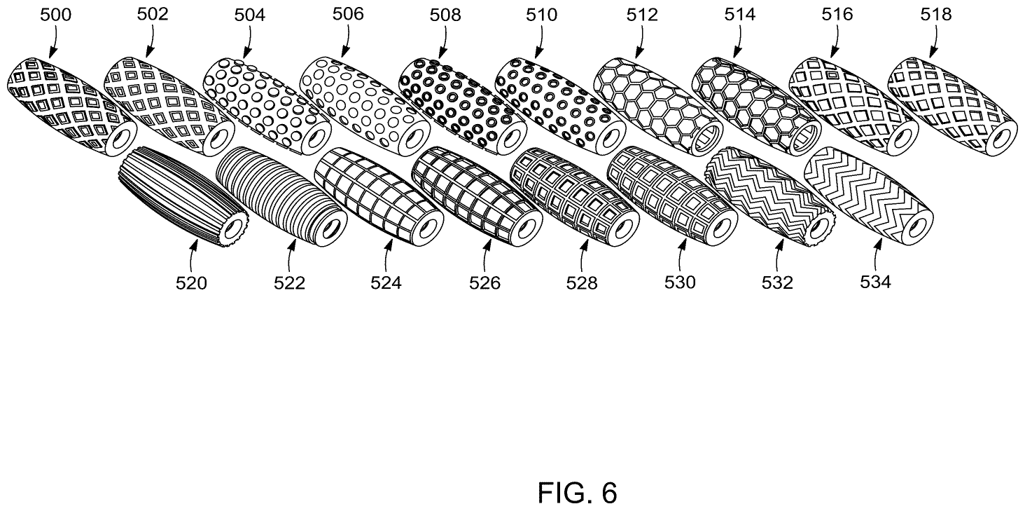

FIG. 6 is a perspective view of a plurality of rollers having traction inducing elements in accordance with one example. Each roller 500-534 is provided to illustrate specific textures and grip patterns on a roller's surface area. Immediately below, each roller will be described in accordance with specific traction inducing characteristics (e.g., texture, pattern, etc.), according to an example of each roller provided. Of course, other roller textures, patterns, and characteristics are contemplated.

In one example, roller 500 features a diamond grid with small, raised diamond elements in a tightly packed arrangement. In one example, roller 502 also includes a diamond grid but further includes small, recessed diamond traction elements. Each diamond element can either be raised elements (roller 500) or recessed elements (roller 502). Of course, a combination of raised and recessed elements can be included. In one example, roller 504 utilizes a circular grid with small, tightly packed raised circles in a helical pattern for uniform traction. In one example, roller 506 includes recessed circle elements, opposite of roller 504. In one example, roller 508 includes medium-sized raised circle element. These circle elements include a sidewall having flexibility when engaging a ground surface. In one example, roller 510 includes recessed circle elements in a helical pattern around the roller. In one example, roller 512 has a hexagonal grid of individual recessed hexagons. In one example, roller 514 includes hexagons similar to roller 512, however each hexagon is formed from a series of ridges. Of course, other polygon shaped elements can be used. In one example, roller 516 includes a raised diamond grid following a helical pattern. In one example, roller 518 includes a recessed diamond grid following a helical pattern around the roller surface.

In one example, roller 520 includes raised linear bands extending along its body in a lengthwise pattern, substantially parallel to the roller axis. In one example, roller 522 includes raised linear bands extending in a perpendicular direction relative to the linear bands in roller 520. In one example, roller 524 includes a square grid having square projections and recessed bands. In one example, roller 526 includes a square grid having linear ridges and recessed square elements. In one example, roller 528 includes a square projection grid having a square recess between each grid segment. In one example, roller 530 includes a square grid having a combination of square cavities defining a square projection therein. In one examples, roller 532 includes linear bands following a lengthwise zig-zag pattern. In one example, roller 534 includes larger linear bands following a lengthwise zig-zag pattern, relative to the bands of roller 532. It is understood that this description of roller patterns is used as an illustrative example of traction inducing elements, and one skilled in the art may alter the pattern of the traction inducing element patterns to include any shape and/or pattern.

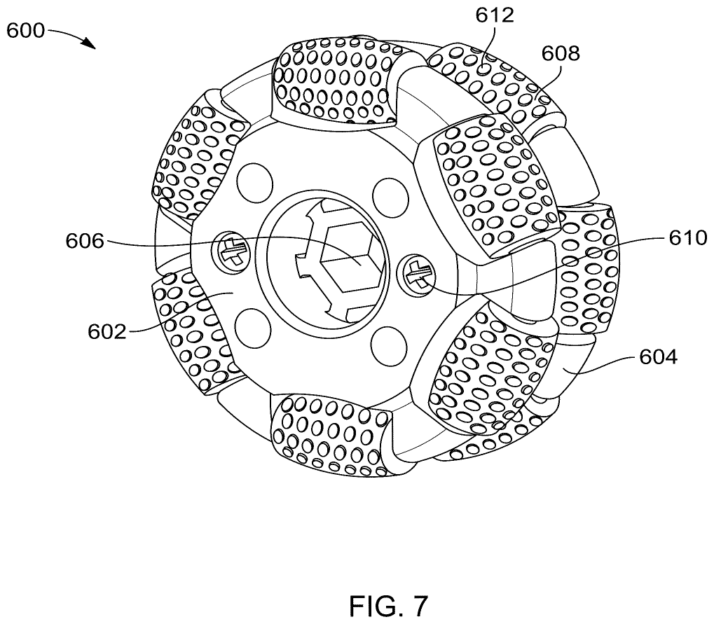

FIG. 7 is a perspective view of an omni-wheel according to one example. Omni-wheel 600 includes first body 602, second body 604, internal bore 606, and rollers 608. Internal bore 606 extends through first body 602 and second body 604 and is shaped to receive a connecting shaft or axle rod. First body 602 is fastened to second body 604 using fasteners 610 to couple the respective body portions together as a singular wheel assembly. First body 602 and second body 604 include rollers 608. Rollers 608, on each respective body, alternate around the circumference of wheel 600. Rollers 608 maintain continuous contact with a floor surface as omni-wheel 600 traverses in a forward direction, backward direction, or lateral direction.

Rollers 608 are mounted directly to body 602 with use of an axle and/or ball bearing system to facilitate rotation across an independent axis. Accordingly, rollers 608 rotate about an independent axis that is perpendicular to the rotation axis of omni-wheel 600. This enables omni-wheel 600 to maneuver in a lateral direction, similar to mecanum wheel 400 discussed above. Rollers 608 are mounted to omni-wheel 600 and are configured to have traction inducing elements 612. Rollers 608 are mounted substantially perpendicular to the axis of rotation of wheel 600. As shown, traction inducing elements 612 can include a series of raised dots. In other examples, traction inducing elements 612 can include any traction pattern as shown and described in FIG. 6 or any alteration of the traction patterns shown and described in the present description.

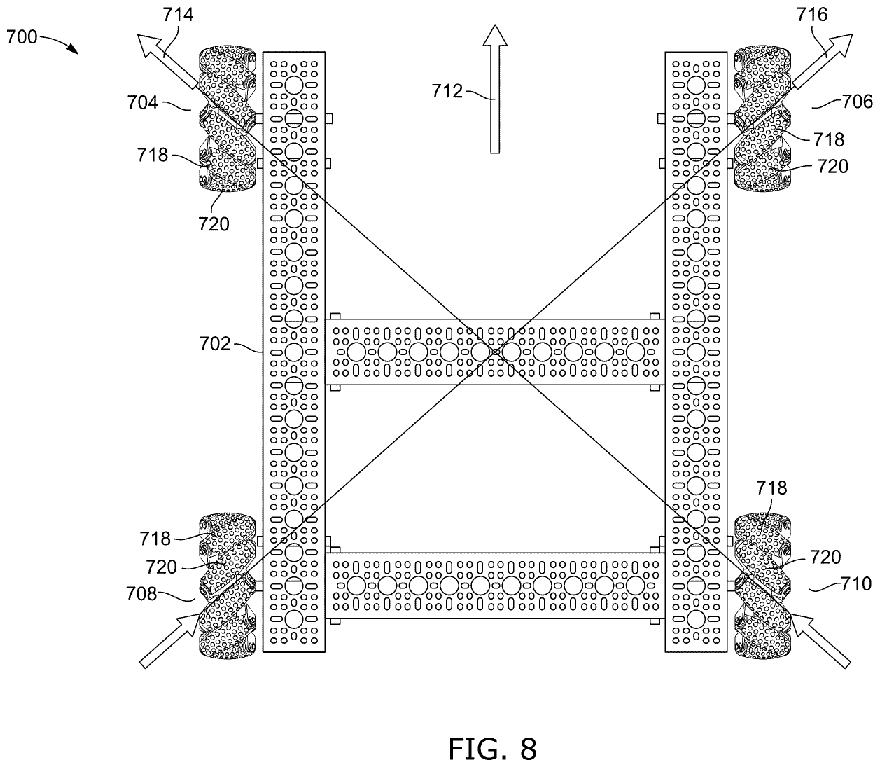

FIG. 8 is a schematic top plan view of a machine having a multidirectional wheel system according to one example. Machine 700 includes frame 702, front left wheel 704, front right wheel 706, rear left wheel 708, and rear right wheel 710. The wheel orientation is with respect to a forward direction of travel of machine 700, indicated by arrow 712. As shown, front left wheel 704 and rear right wheel 710 include rollers having a roller axis along roller axis 714. Additionally, front right wheel 706 and rear left wheel 708 include rollers having a roller axis along roller axis 71. In one example, roller axis 714 is perpendicular to roller axis 716. Thus, the rollers of front left wheel 704 are along a different roller axis than the rollers of front right wheel 706. Similarly, the rollers of rear left wheel 708 are along a different roller axis than the rollers of rear right wheel 710. This configuration allows for multidirectional maneuvers, such as rotations in place and lateral movement. These multidirectional maneuvers are achieved by controlling each of the wheels in opposing directions.

As shown, each wheel (704, 706, 708, 710) is a mecanum style wheel. In other examples, each wheel (704, 706, 708, 710) can be of omni-wheel style. Each wheel (704, 706, 708, 710) includes a plurality of rollers 718 having traction inducing elements 720. Rollers 718 including traction inducing elements 720 can be similar to or the same as the rollers 500-534 as shown and described in FIG. 6, or can include any variation of the roller characteristics described in the present description. Traction inducing elements 720 can each include the same pattern across all rollers, can vary by each roller, and/or can vary by each wheel. Therefore, it is understood that the specific considerations of traction inducing elements 720 can vary based on what is apparent to one skilled in the art.

In summary, various embodiments and examples for systems and methods for a multidirectional wheel assembly having traction elements is provided. Although a multidirectional wheel assembly has been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein, but should be determined only by a fair reading of the claims that follow.

What is claimed is:

1. A multidirectional wheel assembly, comprising:
a central hub configured to rotate about a first axis;
a frame coupled to the central hub, the frame including a plurality of brackets;
a plurality of rollers, wherein each roller, of the plurality of rollers, is connected to each bracket, of the plurality of brackets, and wherein each roller, of the plurality of rollers, rotates independently about a second axis; and
wherein at least one roller, of the plurality of rollers, comprises a surface having a series of raised traction inducing elements.

2. The multidirectional wheel assembly of claim 1, wherein the central hub comprises an internal bore configured to receive an axle rod of a mobile machine.

3. The multidirectional wheel assembly of claim 1, wherein each bracket, of the plurality of brackets, comprises a first panel and a second panel.

4. The multidirectional wheel assembly of claim 3, wherein each roller, of the plurality of rollers, is mounted between the first panel and the second panel of each bracket, of the plurality of brackets.

5. The multidirectional wheel assembly of claim 1, wherein the second axis is perpendicular to the first axis.

6. The multidirectional wheel assembly of claim 1, wherein the second axis forms an angle between 30-50 degrees relative to the first axis.

7. The multidirectional wheel assembly of claim 1, wherein the series of raised traction inducing elements comprises a pattern of raised projections.

8. The multidirectional wheel assembly of claim 7, wherein the pattern of raised projections comprises a plurality of dotted projections.

9. A multidirectional wheel, comprising:
a wheel axis of rotation around which the multidirectional wheel is configured to rotate;
a plurality of rollers that are each an integrated part of the multidirectional wheel, wherein each roller, of the plurality of rollers, rotates around a roller axis that is not parallel to the wheel axis of rotation; and
wherein each roller, of the plurality of rollers, comprises a surface material having raised traction inducing elements.

10. The multidirectional wheel of claim 9, further comprising an internal bore configured to receive an axle rod of a mobile machine.

11. The multidirectional wheel of claim 10, wherein the mobile machine is a mobile robot configured to perform multidirectional maneuvers across a surface.

12. The multidirectional wheel of claim 11, wherein the plurality of rollers maintains continuous contact with the surface as the multidirectional wheel rotates around the wheel axis of rotation.

13. A plurality of rollers integrated into a multidirectional wheel assembly, wherein each roller in the plurality includes a repeated series of raised traction inducing elements.

14. The plurality of rollers of claim 13, wherein each roller of the plurality comprises a cylindrical body having a tapered shape.

15. The plurality of rollers of claim 13, wherein each roller in the plurality rotates around a rotation axis independent from a wheel axis in which the multidirectional wheel rotates around.

16. The plurality of rollers of claim 13, wherein the repeated series of raised traction inducing elements comprises a pattern of raised projections.

17. The plurality of rollers of claim 16, wherein the pattern of raised projections comprises a helical pattern around a surface of each roller in the plurality.

18. The plurality of rollers of claim 16, wherein the pattern of raised projections a plurality of raised ridge elements.

19. The plurality of rollers of claim 18, wherein the plurality of ridge elements are cross hatched ridge elements.

20. The plurality of rollers of claim 13, wherein the repeated series of raised traction inducing elements comprises a plurality of raised linear bands.
